(19) United States
(12) Patent Application Publication
(10) Pub. No.: US 2023/0086212 A1
(43) Pub. Date: Mar. 23, 2023

(54) CONTEXT BASED PRINT CONTENT PREDICTION

(71) Applicant: INTERNATIONAL BUSINESS MACHINES CORPORATION, Armonk, NY (US)

(72) Inventors: ASHOK KUMAR KRISHNEGOWDA, BANGALORE (IN); RAGHUVEER PRASAD NAGAR, KOTA (IN); ADITI CHAKRABORTY, BANGALORE (IN); PRASHANT S NAYAK, BANGALORE (IN)

(21) Appl. No.: 17/477,963

(22) Filed: Sep. 17, 2021

(51) Int. Cl. G06K 15/02; G06F 3/12

(52) U.S. Cl. CPC G06K 15/1809; G06K 15/1805; G06F 3/1204; G06F 3/1205; G06F 3/1242

(57) ABSTRACT

A method, system, and computer program product for context-based print content prediction are provided. The method receives a print command from a computing device. In response to receiving the print command, a set of user activities are identified which are associated with the computing device. The method determines a context of the print command based on the set of user activities. A content to be printed is determined based on the print command and the context of the print command. A print recommendation is generated for the content to be printed based on the context of the print command. The method generates a print command user interface containing the print recommendation.

### BACKGROUND

Digital documents are increasingly commonplace in printing systems. Current document viewers enable viewing of digital documents on a display device for a variety of document formats. Document viewers generally enable read access to digital documents, while differing document viewers enable varying types of write or document interaction. Some document viewers enable annotation functionality to modify portions of digital documents. These document viewers often provide a print feature for digital documents displayed by the document viewer. Print features of document viewers may be limited in functionality to printing a whole document or specified pages to predetermined printer systems associated with a given computing device. These print features employ direct user interactions with an interface of the document viewer to determine a digital document or a portion thereof to be printed.

### SUMMARY

According to an embodiment described herein, a computer-implemented method for context-based print content prediction is provided. The method receives a print command from a computing device. In response to receiving the print command, a set of user activities are identified which are associated with the computing device. The method determines a context of the print command based on the set of user activities. A content to be printed is determined based on the print command and the context of the print command. A print recommendation is generated for the content to be printed based on the context of the print command. The method generates a print command user interface containing the print recommendation.

According to an embodiment described herein, a system for context-based print content prediction is provided. The system includes one or more processors and a computer-readable storage medium, coupled to the one or more processors, storing program instructions that, when executed by the one or more processors, cause the one or more processors to perform operations. The operations receive a print command from a computing device. In response to receiving the print command, a set of user activities are identified which are associated with the computing device. The operations determine a context of the print command based on the set of user activities. A content to be printed is determined based on the print command and the context of the print command. A print recommendation is generated for the content to be printed based on the context of the print command. The operations generate a print command user interface containing the print recommendation.

According to an embodiment described herein, a computer program product for context-based print content prediction is provided. The computer program product includes a computer-readable storage medium having program instructions embodied therewith, the program instructions being executable by one or more processors to cause the one or more processors to receive a print command from a computing device. In response to receiving the print command, a set of user activities are identified which are associated with the computing device. The computer program product determines a context of the print command based on the set of user activities. A content to be printed is determined based on the print command and the context of the print command. A print recommendation is generated for the content to be printed based on the context of the print command. The computer program product generates a print command user interface containing the print recommendation.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for context-based print content prediction, according to at least one embodiment.

FIG. 3 depicts a flow diagram of a computer-implemented method for context-based print content prediction, according to at least one embodiment.

FIG. 4 depicts a block diagram of a computing system for context-based print content prediction, according to at least one embodiment of the present disclosure.

FIG. 5 is a schematic diagram of a cloud computing environment in which concepts of the present disclosure may be implemented, in accordance with an embodiment of the present disclosure.

FIG. 6 is a diagram of model layers of a cloud computing environment in which concepts of the present disclosure may be implemented, in accordance with an embodiment of the present disclosure.

### DETAILED DESCRIPTION

The present disclosure relates generally to methods for context-based print content prediction. More particularly, but not exclusively, embodiments of the present disclosure relate to a computer-implemented method for an artificial intelligence (AI) and Internet of Things (IoT) based system to derive context for received print commands, determine a context-based print content, provide recommendations, and execute print commands for the provided recommendations. The present disclosure relates further to a related system for context-based print content prediction, and a computer program product for operating such a system.

Digital documents are increasingly commonplace in printing systems. Current document viewers enable viewing of digital documents on a display device for a variety of document formats. Document viewers generally enable read access to digital documents, while differing document viewers enable varying types of write or document interaction. When viewing a document with a large number of pages, a user may be interested in a subset of pages. Document viewers often provide a print feature for digital documents displayed by the document viewer. Where a user is interested in a subset of pages, the user may not want to limit a print range of the document to the subset of pages of interest. Print features of document viewers may be limited in functionality to printing a whole document or specified pages to predetermined printer systems associated with a given computing device. These print features employ direct user interactions with an interface of the document viewer to determine a digital document or a portion thereof to be printed. However, when using a print feature, a user may be required to explicitly insert specified page numbers or page ranges for printing. Users may miss or accidentally omit pages from a dialog box, and thus omit pages from a printed document. As the subset of pages become more fractured, a likelihood increases of missing pages or portions of the subset of pages of interest. For example, where a user desires to print a page range of 1-5, 6, 9-11, 77-81, 124, 146, and 189-198, the user is likely to miss one or more pages from a generated print job, depending on a style and functionality of the print function of the document viewer.

Embodiments of the present disclosure enable context-based print content prediction. The present disclosure enables an AI and IoT-based system to derive context of received print commands. Embodiments of the present disclosure determine content for received print commands from a derived context of the print command. The derived context may be a print context, a user context, a location context, or combinations thereof. The present disclosure enables creation of print recommendations based on the derived context and the determined content associated with the print command. In some embodiments, the print recommendation generates or prepopulates pages to be printed for a digital document, adds pages to a list of pages provided within the print command, adds or changes a print location associated with the print command, and combinations thereof. Embodiments of the present disclosure provide the print recommendation within a print command user interface, where the user associated with the print command may respond to, accept, or modify the print recommendation. Some embodiments of the present disclosure provide for automated execution of print recommendations to fulfill the print command. Embodiments of the present disclosure reduce user error while inputting print ranges into a document viewer and avoids printing unnecessary pages. Some embodiments of the present disclosure reduce user effort, time expenditure, and streamline user interface experience while interacting with print functions of a document viewer. Embodiments of the present disclosure may be used for a variety of document viewers, printing systems, and computing devices or systems.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

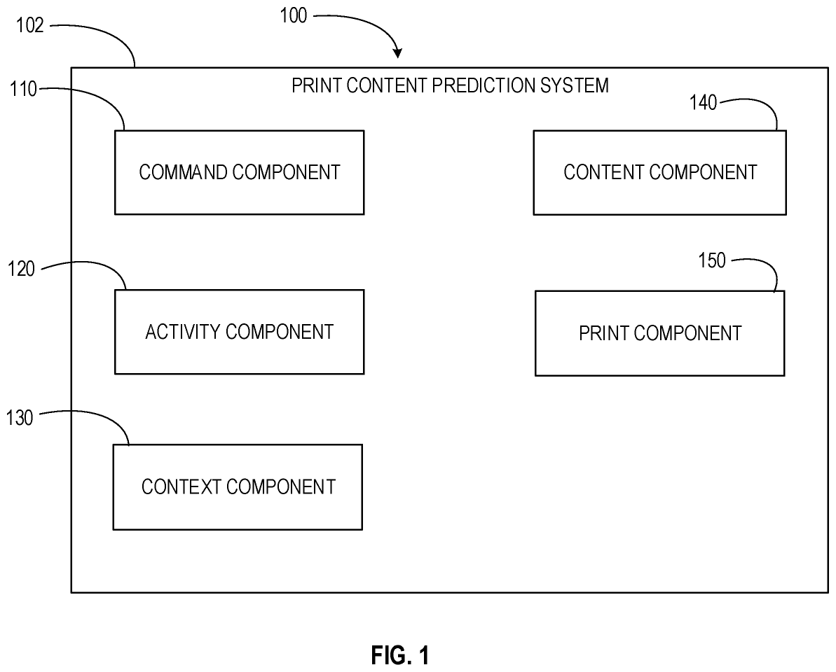

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a print content prediction system 102. The print content prediction system 102 may comprise a command component 110, an activity component 120, a context component 130, a content component 140, and a print component 150. The command component 110 receives print commands from computing devices. The activity component 120 identifies activities, locations, profiles, and other user attributes. The context component 130 determines context of print commands and user contexts to enable print predictions and execution of print commands. The content component 140 determines content to be printed based on print commands, context of print commands, user contexts, and user activities. The print component 150 generates print recommendations and print command user interfaces to enable execution of print commands. Although described with distinct components, it should be understood that, in at least some embodiments, components may be combined or divided, and/or additional components may be added without departing from the scope of the present disclosure.

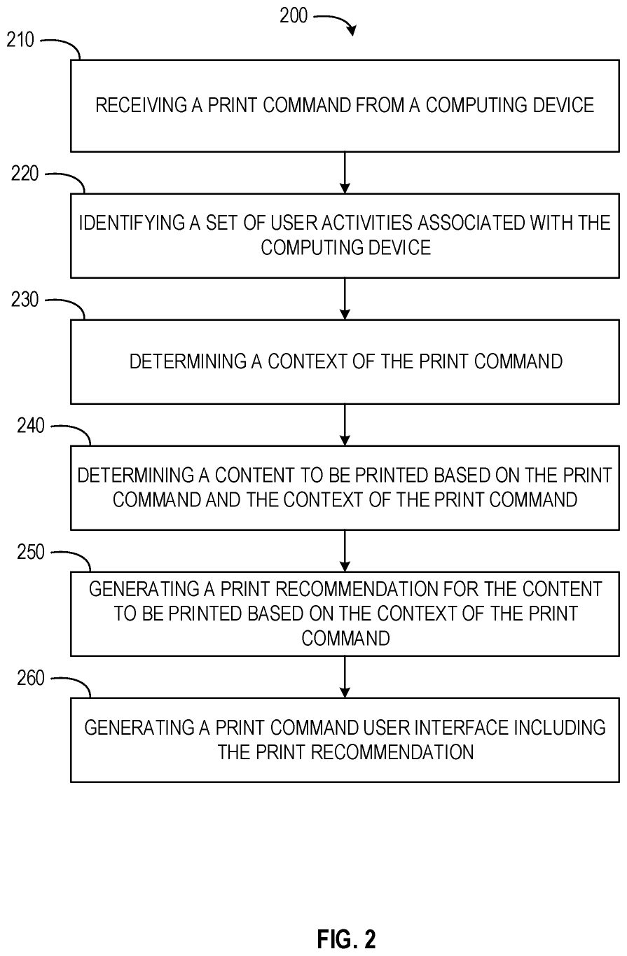

Referring now to FIG. 2, a flow diagram of a computer-implemented method 200 is shown. The computer-implemented method 200 is a method for context-based print content prediction. In some embodiments, the computer-implemented method 200 may be performed by one or more components of the computing environment 100, as described in more detail below.

At operation 210, the command component 110 receives a print command from a computing device. The print command may be received through a user interface interaction, such as selection of a print button in a document viewer by a user. The document being viewed in the document viewer may be stored locally, stored in a server or cloud infrastructure, or stored on another computing device accessible by the user. For example, the document being viewed, and subject to a print command, may be stored on a content delivery network (CDN).

For example, the print command may be received from a student attempting to print from a large document in advance of an assessment over a smaller portion of material within the large document. Once the print command is received by the command component 110 by the student, the content prediction system 102 performs operations to generate and execute a context-based print content prediction. By way of further example, a presenter in a first geographic location may have an upcoming presentation in a second geographic location. The presenter may have a large text containing a subset of topics of interest related to the presentation. Once the print command is received by the command component 110 from the presenter, the content prediction system 102 performs operations to generate and execute a context-based print content prediction for the presenter.

The print command may be received by voice, gesture, or any other user interface interaction of a computing device. In some instances, the print command is received through a user interface or input device connected to a printing device or printing system. The print command may be received at the computing device, at a printing device physically connected to the computing device, or at a printing device logically connected to the computing device. The printing device may be logically connected to the computing device through a network or cloud to which both the printing device and the computing system are connected. The printing device may also be logically connected to the computing device, where the printing device and the computing device are on different networks or clouds and the print command is transmitted from a first network or cloud associated with the computing device to a second network or cloud associated with the printing device.

The user associated with the print command may be an individual user, a group of users, or an organization. The user may use or interact with the print content prediction system 102 after signing up or logging into the print content prediction system 102. In some instances, the user may log in or sign up for the print content prediction system 102 and link one or more applications, document viewers, or document readers with the print content prediction system 102. In signing up or logging into the print content prediction system 102, the user may enable the print content prediction system 102 to interact with or retrieve data from certain linked applications. The user may enable interaction with or retrieval of certain types of data in linked applications such as itinerary information, selected email data, selected SMS messages, user interface interactions, or other acceptable and relevant data. The user may disable interaction of the print content prediction system 102 with any desired application to maintain a desired level of information privacy.

At operation 220, the activity component 120 identifies a set of user activities associated with the computing device. In some embodiments, the set of user activities are identified in response to the command component 110 receiving the print command. The set of user activities may be relevant user data to which the user has provided access to the print content prediction system 102 or the activity component 120. The user may provide access selectively, enabling the print content prediction system 102 or the activity component 120 certain user activities or user data without providing access to other information which the user considers sensitive.

User activities may be actions, operations, geographic information, or any other information providing information relating to a user's intent relevant to a print command or initiating a print command. In some embodiments, at least a portion of user activities are activities which modify a document containing the content to be printed. The user activities may include recent user activities on a single computing device, or user activities across a set of computing devices, location information, calendar information (e.g., upcoming events and attended trainings), communications (e.g., selected emails or SMS messages), social media data (e.g., profile information, skills, or areas of interest), user profiles, attended trainings, combinations thereof, or any other user activities or user information.

In some embodiments, at least a portion of user activities are interactions with a user interface displaying a document containing the content to be printed. The user activities interacting with a user interface may include selection of a print function, selection of pages within a document, annotation of pages within a document, modification of pages within a document, page operations, combinations thereof, or any other suitable user interface interactions. Page operations may include page rotation, visual changes, brightness, contrast, search operations, identified search results on a page, links or relationships between pages, or any other operations relevant to viewing or interacting with a document. In the example of a student preparing for an assessment of a portion of a large text, the user interactions may be searching of selected pages within the large document, scrolling through selected pages of the large document, dwell time on selected pages within the large document, or annotation of selected pages within the large document. In the example of the presenter traveling from a first location to a second location for a presentation, the user interactions may include information from the presenter's calendar indicating a topic of the presentation and location of the presentation.

At operation 230, the context component 130 determines a context of the print command. The context of the print command may indicate a purpose of the print, a usage of the print, one or more users associated with the print, and a timing of the print. The purpose of the print may indicate a reason for the user printing the document, such as printing for a scheduled training session. The usage of the print may indicate a manner in which the print will be used, such as a user printing a document for use during planned overnight travel without electronic communications. The users associated with the print may indicate who or how many users are to receive the print, such as a user printing a document for distribution to audience members of a presentation. The timing of the print may indicate when a print is to be used, such as a specified event/time of using the printed materials. In some instances, the context of the print command is determined based on determining information within a document about which the user is not interested. In some instances, the context component 130 may determine the context of the print command based on portions of the document with which the user has not interacted, portions of the document which have not been annotated, portions of the document which are not related to skills, training, or messaging of the user, or other suitable and relevant interest factors. In such embodiments, the context component 130 determines the context of the print command by processing meta-data available for portions of the document for which the user has demonstrated interest or for which the user has demonstrated no interest. The context component 130 may determine, from the available meta-data, predictions for each page, section, paragraph, or line within the document. The predictions determined for portions of the document may be represented by percentages or values indicating a likelihood of interest of the user for that portion of the document. The predictions may include values or percentages for specified pages to be printed or page numbers to be downloaded to a computing device in advance of travel for access without available networks.

In the example of the presenter, the context of the print command may indicate the travel from the first location to the second location and the intended audience of the presentation to determine the purpose of the print command is for subject matter refreshing for a presentation to a peer or near-peer audience. Where the context of the print command is determined to be a subject matter refresher, the context component 130 may also determine a travel time from the first location to the second location and a number of pages viewable during the travel time.

In some embodiments, the context of the print command is determined based on the set of user activities. In some instances, the context of the print command is determined based on a user context. The context of the print command may also be determined based on the set of user activities and the user context.

At operation 240, the content component 140 determines a content to be printed, content of interest to the user, or content relevant to the context. The content may be determined based on the print command. In some embodiments, the content is determined based on the context of the print command. The content may be determined based on predictions of interest generated by the context component 130. In some instances, the content is determined based on the print command, the context of the print command, and the predictions of interest. In the example of the presenter, the content component 140 may determine the content to be printed as a subset of pages of relevant material from the large text, where the subset corresponds to a viewable number of pages during the travel time of the presenter.

The content component 140 may determine the content to be printed by associating contents of the document, on which the print command was issued, with the context of the print command. The content to be printed may be pages of a document, sections of a document, or combinations thereof. The content to be printed may also include lower level constructs of a document. For example, the constructs to be printed may be specified sentences or paragraphs within the document (e.g., a third sentence of a second paragraph of a specified section or page).

At operation 250, the print component 150 generates a print recommendation for the content to be printed. In some embodiments, the print recommendation is generated based on the context of the print command. The print recommendation may include the content to be printed. The print recommendation may include the content to be printed and content indicated within the print command. In some instances, the print recommendation includes a print time, a print location, a number of copies of the print, a collation suggestion for the content to be printed, combinations thereof, and any other suitable print information. In some embodiments, the print recommendation includes modifications to the content to be printed. For example, the print recommendation may include a suggestion to print pages with annotations, modifications, or changes to the document generated by a user. The print recommendation may also include suggestions for printing unmodified and modified versions of the content to be printed. Such print recommendations may highlight or draw attention to changes made within the document and content to be printed. In the example of the student preparing for an assessment, the print component 150 may generate the print recommendation including pages with which the student interacted, annotated, or reviewed or pages included in an email discussing the assessment.

At operation 260, the print component 150 generates a print command user interface. The print command user interface may contain the print recommendation or a representation of the print recommendation. The print command user interface may present the print recommendation as an optional interaction for the user, such that the user may print desired portions of the document without interacting with the print recommendation on the print command user interface. In some instances, the print command user interface presents the print recommendation as a mandatory selection, such that the user interacts with the print recommendation in order to initiate or execute the print command. The print command user interface may present the print recommendation in connection with other print options or print operations. The other print options or print operations, such as page orientation or color printing, may be unmodified regardless of the print recommendation. In some instances, selection of the print recommendation may modify one or more other print options or print operations presented within the print command user interface.

In some embodiments, the content to be printed or the print recommendation may be printed automatically. Automatic printing of the content to be printed or the print recommendation may be performed with the print command user interface or in response to user interaction with the print command user interface. In some embodiments, automatic printing of the content to be printed may be performed without user interaction with the print recommendation or the print command user interface.

In some instances, the print content prediction system 102 uses print recommendations for reinforcement learning. In such instances, the print content prediction system 102 uses acceptance or execution of print commands including the print recommendations as feedback to reinforce the context and content determinations of the print content prediction system 102. In some instances, the print content prediction system 102 uses user feedback collected through using the user action on the recommendation or lack of user action for a print recommendation to provide information for machine learning models to improve or reinforce the context and content determinations of the print content prediction system 102. Machine learning models of the print content prediction system 102 may be rewarded when a user selects “OK” to print or execute the print recommendation in a pop-up window. Such selection may indicate that the identified content to be printed will be printed and was correctly determined for the user. Machine learning models of the print content prediction system 102 may be penalized where a user declines the print recommendation or picks a “Let Me Select” button within the print command user interface.

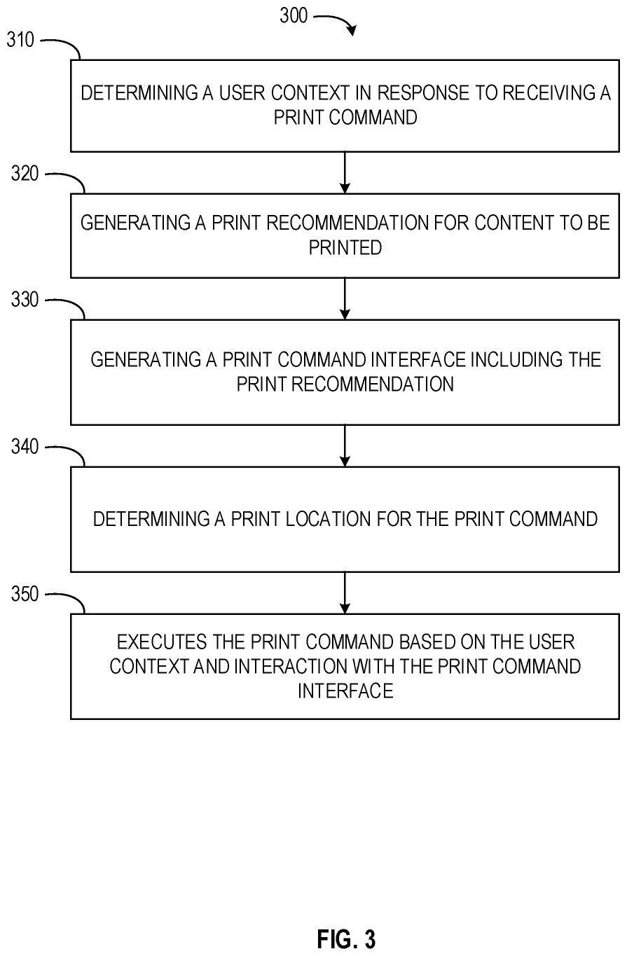

FIG. 3 shows a flow diagram of an embodiment of a computer-implemented method 300 for context-based print content prediction. The method 300 may be performed by or within the computing environment 100. In some embodiments, the method 300 comprises or incorporates one or more operations of the method 200. In some instances, operations of the method 300 may be incorporated as part of or sub-operations of the method 200.

In operation 310, the context component 130 determines a user context. In some embodiments, the user context is determined in response to receiving the print command. The user context may be determined as a location, activity, travel status, connection status, itinerary, or combination thereof of the user. The user context may inform determination of where, how, or why the document is being printed.

In some embodiments, the context of a print command is determined based in part on the user context. In some instances, the content of the print may be determined based in part on the user context and the context of the print command.

In operation 320, the print component 150 generates a print recommendation for the content to be printed. In some instances, the print recommendation is generated by the print component 150 in a manner similar to or the same as described above with respect to operation 250.

In operation 330, the print component 150 generates a print command user interface. In some instances, the print command user interface is generated in a manner similar to or the same as described above with respect to operation 260.

In operation 340, the print component 150 determines a print location for the print command. The print location may be determined based on the user context, a set of user activities, or combinations thereof. In some instances, the print location is determined as a location associated with a user's travel destination, itinerary, or event schedule.

In operation 350, the print component 150 executes the print command based on the print location. The print command may be executed based on the user context and an interaction with the print command user interface. For example, the print command may be executed at a printing device or printing system located at the print location associated with the user and the user context.

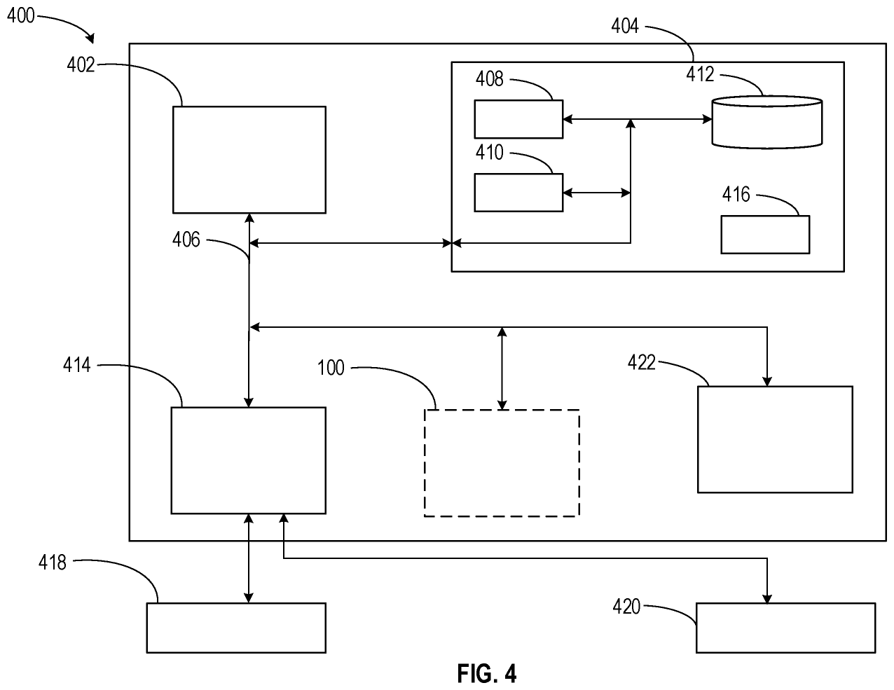

Embodiments of the present disclosure may be implemented together with virtually any type of computer, regardless of the platform is suitable for storing and/or executing program code. FIG. 4 shows, as an example, a computing system 400 (e.g., cloud computing system) suitable for executing program code related to the methods disclosed herein and for context-based print content prediction.

The computing system 400 is only one example of a suitable computer system and is not intended to suggest any limitation as to the scope of use or functionality of embodiments of the present disclosure described herein, regardless, whether the computer system 400 is capable of being implemented and/or performing any of the functionality set forth hereinabove. In the computer system 400, there are components, which are operational with numerous other general-purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 400 is shown in the form of a general-purpose computing device. The components of computer system/server 400 may include, but are not limited to, one or more processors 402 (e.g., processing units), a system memory 404 (e.g., a computer-readable storage medium coupled to the one or more processors), and a bus 406 that couple various system components including system memory 404 to the processor 402. Bus 406 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random-access memory (RAM) 408 and/or cache memory 410. Computer system/server 400 may further include other removable/non-removable, volatile/non-volatile computer system storage media. By way of example only, a storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, the system memory 404 may include at least one program product having a set (e.g., at least one) of program modules that are configured to carry out the functions of embodiments of the present disclosure.

The program/utility, having a set (at least one) of program modules 416, may be stored in the system memory 404 by way of example, and not limiting, as well as an operating system, one or more application programs, other program modules, and program data. Program modules may include one or more of the command component 110, the activity component 120, the context component 130, the content component 140, and the print component 150, which are illustrated in FIG. 1. Each of the operating systems, one or more application programs, other program modules, and program data or some combination thereof, may include an implementation of a networking environment. Program modules 416 generally carry out the functions and/or methodologies of embodiments of the present disclosure, as described herein.

The computer system/server 400 may also communicate with one or more external devices 418 such as a keyboard, a pointing device, a display 420, etc.; one or more devices that enable a user to interact with computer system/server 400; and/or any devices (e.g., network card, modem, etc.) that enable computer system/server 400 to communicate with one or more other computing devices. Such communication can occur via Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of computer system/server 400 via bus 406. It should be understood that, although not shown, other hardware and/or software components could be used in conjunction with computer system/server 400. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

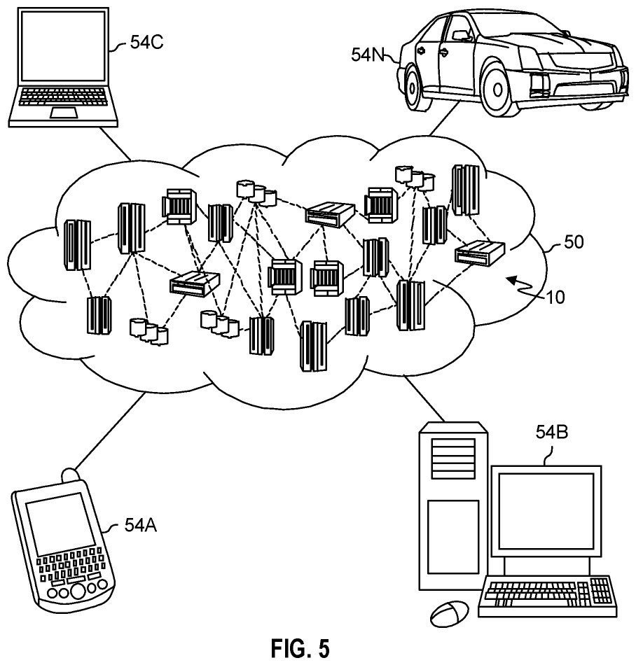

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

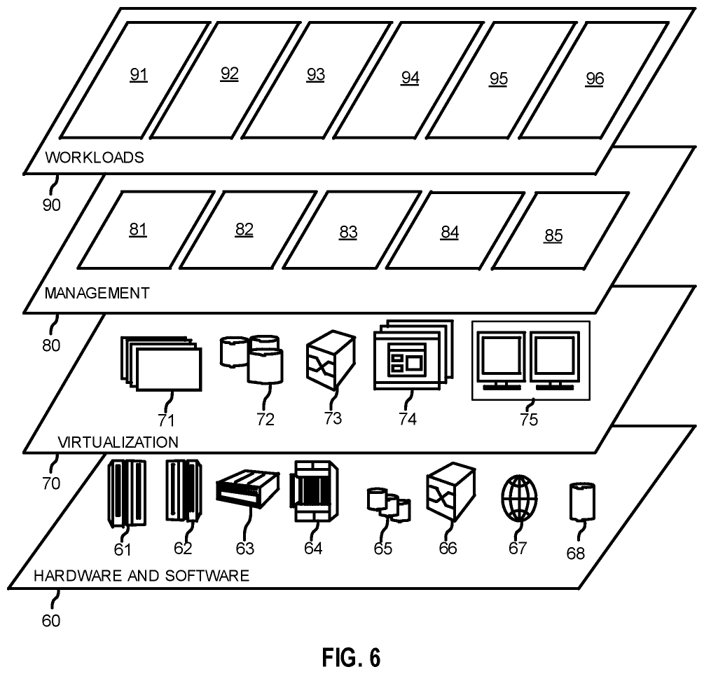

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and print context processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a print command from a computing device;
in response to receiving the print command, identifying a set of user activities associated with the computing device;
determining a context of the print command based on the set of user activities;
determining a content to be printed based on the print command and the context of the print command;
generating a print recommendation for the content to be printed based on the context of the print command; and
generating a print command user interface containing the print recommendation.

2. The method of claim 1, wherein at least a portion of user activities of the set of user activities modify a document containing the content to be printed.

3. The method of claim 1, wherein at least a portion of the set of user activities are interactions with a user interface displaying a document containing the content to be printed.

4. The method of claim 1, further comprising:
determining a user context in response to receiving the print command.

5. The method of claim 4, wherein the context of the print command is determined based in part on the user context.

6. The method of claim 4, further comprising:
executing the print command based on the user context and an interaction with the print command user interface.

7. The method of claim 4, further comprising:
determining a print location for the print command based on the user context.

8. A system, comprising:
one or more processors; and
a computer-readable storage medium, coupled to the one or more processors, storing program instructions that, when executed by the one or more processors, cause the one or more processors to perform operations comprising:
receiving a print command from a computing device;
in response to receiving the print command, identifying a set of user activities associated with the computing device;
determining a context of the print command based on the set of user activities;
determining a content to be printed based on the print command and the context of the print command;
generating a print recommendation for the content to be printed based on the context of the print command; and
generating a print command user interface containing the print recommendation.

9. The system of claim 8, wherein at least a portion of user activities of the set of user activities modify a document containing the content to be printed.

10. The system of claim 8, wherein at least a portion of the set of user activities are interactions with a user interface displaying a document containing the content to be printed.

11. The system of claim 8, wherein the operations further comprise:
determining a user context in response to receiving the print command.

12. The system of claim 11, wherein the context of the print command is determined based in part on the user context.

13. The system of claim 11, wherein the operations further comprise:
executing the print command based on the user context and an interaction with the print command user interface.

14. The system of claim 11, wherein the operations further comprise:
determining a print location for the print command based on the user context.

15. A computer program product comprising a computer readable storage medium having program instructions embodied therewith, the program instructions being executable by one or more processors to cause the one or more processors to perform operations comprising:
receiving a print command from a computing device;
in response to receiving the print command, identifying a set of user activities associated with the computing device;
determining a context of the print command based on the set of user activities;
determining a content to be printed based on the print command and the context of the print command;
generating a print recommendation for the content to be printed based on the context of the print command; and
generating a print command user interface containing the print recommendation.

16. The computer program product of claim 15, wherein at least a portion of the user activities of the set of user activities modify a document containing the content to be printed and at least a portion of the set of user activities are interactions with a user interface displaying a document containing the content to be printed.

17. The computer program product of claim 15, wherein the operations further comprise:
determining a user context in response to receiving the print command.

18. The computer program product of claim 17, wherein the context of the print command is determined based in part on the user context.

19. The computer program product of claim 17, wherein the operations further comprise:
executing the print command based on the user context and an interaction with the print command user interface.

20. The computer program product of claim 17, wherein the operations further comprise:
determining a print location for the print command based on the user context.
